(19) United States
(12) Patent Application Publication
(10) Pub. No.: US 2004/0117727 A1
(43) Pub. Date: Jun. 17, 2004

(54) Method and apparatus for processing files utilizing a concept of weight so as to visually represent the files in terms of whether the weight thereof is heavy or light

(76) Inventor: Shinya Wada, Tokyo (JP)

Correspondence Address: KATTEN MUCHIN ZAVIS ROSENMAN, 575 MADISON AVENUE, NEW YORK, NY, 10022-2585, US

(21) Appl. No.: 10/706,617

(22) Filed: Nov. 12, 2003

(30) Foreign Application Priority Data
Nov. 12, 2002 (JP) 2002-328853

(51) Int. Cl. G06F 17/21

(52) U.S. Cl. 715/500

(57) ABSTRACT

On a screen a file processing apparatus displays values of an attribute related to a plurality of files using a concept of weight. The weight of each file is represented in one embodiment by spherical objects submerged into the water and displayed on the screen. For example, a first spherical object represents a file whose data size is large, and is sunk near bottom. And a second spherical object represents a file whose data size is light and is floating near the water surface.

### BACKGROUND OF THE INVENTION

1. Field of the Invention

The present invention relates to method and apparatus for processing files, and it particularly relates to a technology for managing or organizing a plurality of files on the computer.

2. Description of the Related Art

The rapid spread of personal computers (hereinafter referred to as PCs) has now slowed down, and the current trend is the marked versatility of functions in hardware such as PDAs (Personal Digital Assistants), portable telephones and game machines. For example, PDAs, which are equipped with wireless communication functions, can now use networks no matter where they are. Moreover, advances in high-definition display screen and CPU processing capacity have made it easier for such hardware to carry out high-load processing, such as moving picture processing which has so far been only possible on a PC. Similarly, portable telephones are increasingly multi-functional with camera function, moving picture function, game function and the like.

The functions of game machines are being extended by the addition of network function, hard disk and the like. And the external connection terminals employed for them are now of the types similar to those on a PC, thus ensuring their newly-added multiple usage and flexibility. This way, the barriers that used to exist between such hardware and PCs are being steadily removed, and such hardware's increasingly high graphic processing capabilities, in particular, are now even threatening the position of PCs.

As a variety of electronic devices grow more and more multi-functional, their increased flexibility is attracting and bringing in more users of their own. Moreover, the concepts of files and folders as seen in the file system, which used to be characteristic of PCs only, are now being introduced to the users of electronic equipment other than PCs as well.

However, some intrinsic limitations of such hardware in the electronic equipment other than PCs still persist. For example, the small size of the screen or the simplicity of control devices can pose visual and operational restrictions. Thus, if the display and control interfaces currently employed for PCs are to be pursued, then it may lead to a reduced accessibility to such hardware. Therefore, it is essential to develop interfaces using their own expression if the potential abilities for a variety of electronic equipment is to be fully exploited.

### SUMMARY OF THE INVENTION

The present invention has been made in view of the foregoing circumstances and an object thereof is to realize a display that ensures easier visual grasp of the characteristics of data.

A preferred embodiment according to the present invention relates to a file processing apparatus. This apparatus includes: an attribute input unit which acquires a value of an attribute for at least one file in order to represent a value of a predetermined attribute for an intended file by using a concept of weight; a comparison processing unit which compares the value of an attribute with a reference value; a position determining unit which sets, based on a result obtained from the comparison processing unit, a relative display position of a predetermined object that represents symbolically the weight; and a display processing unit which visually represents the value of the attribute in terms of whether the weight is heavy or light, by displaying the object at the display position on a screen set by the position determining unit.

Here a “file” mainly means a program or a collection of data visualized by an icon on a screen. It may also mean a hierarchy, such as a folder or directory, visualized by an icon in a hierarchical file system or an offshoot document related to the body of a reference target, such as a so-called shortcut or alias visualized by an icon. A file may have a file name which includes an extension at the end. A file may also be a text file containing character data or a binary file containing binary data. An “attribute” may be a characteristic of a file or a parameter used as a reference for comparison with another file, which may include the date of file preparation or updating, the data size, the importance of each file to be set by the user, the type of file to be determined by data format or file usage, the number of files contained in a folder or the number of folders, and the count or frequency of file updating. An “attribute” may also be a parameter showing the level of a character to be controlled by the user in game software. A “values to be used as reference” may be the value of an attribute related to another file or the value showing the unused capacity of the storage area of a storage.

An “object” may symbolize a file or a folder or may collectively stand for a plurality of files or a plurality of folders. An object may be displayed on the screen as an image of a tangible object with a mass in the real world, such as a “sphere”, a “particle” or a “weight”, or in the form of an icon. For example, a “sphere” may be able to symbolize the weight of a thing because it may fall under its own weight or the force of gravity and may bounce on the ground or, if thrown into the water, may sink or float up. A scene of measuring the weight of things may be represented by an object like a weight and scale.

A file processing apparatus according to the present embodiment may be realized as an electronic equipment, such as a PC, a PDA, a game machine or a portable telephone. Recently, electronic equipment other than PCs can even use file systems primarily designed for PCs. However, PDAs or portable telephones, whose screens are small, or game machines, which are used away from the TV screen, often present much poorer visibility of characters than PCs. Hence, if a file name and the attributes of a file are displayed simply as a character string on the screen, the user may find it difficult to read them when selecting a desired file. This may also develop into some operational difficulties. Moreover, if a large number of files are to be displayed on a small screen, there will be little space left for displaying information on attributes.

In this embodiment, visual limitations are reduced by displaying attributes of a file not through the use of characters but in a form that helps the user's intuitive grasp. Further, operational limitations are also reduced by simplifying the contents of display. Moreover, a new operation method may be presented by incorporating a tilt sensor in the whole or a part of this apparatus.

Another preferred embodiment according to the present invention relates to a method of processing files. This method includes: setting a relative display position of a predetermined object that symbolically represents the files in terms of whether the weight thereof is heavy or light, based on a value of a predetermined attribute for an intended file, in order to represent the value of a predetermined attribute therefor by using a concept of weight; and representing visually the weight by displaying the object at the relative display position on a screen.

Still another preferred embodiment according to the present invention relates also to a method of processing files. This method includes: acquiring values of a predetermined attribute for a plurality of intended files in order to represent the values of a predetermined attribute therefor by using a concept of weight; setting, for each of the plurality of files, a relative display position of a predetermined object that represents symbolically the files in terms of whether the weight thereof is heavy or light, based on the values of a predetermined attribute; and displaying the objects of the plurality of files at the respective display positions on a screen, and expressing visually comparison of the weights of the objects via another object that symbolizes weight measurement.

“Another object that symbolizes weight measurement” is a character that is used to display on the screen a comparison of weights between files or a measurement of a total weight of a plurality of files. Such an object used for instance is a weighing device, measuring device, balance, balloon or the like which is used for measurement in the real world.

Still another preferred embodiment according to the present invention relates also to a method of processing files. This method includes: acquiring values of a predetermined attribute for a plurality of files, in order to represent the values of a predetermined attribute for intended files by using a concept of weight; setting a temporary sequence for the plurality of files; determining, based on the temporary sequence, a temporary display position of a predetermined object that symbolically represents the files in terms of whether the weight thereof is heavy or light; displaying an object that corresponds to the plurality of files, at the temporary display position on a screen; comparing the values of a predetermined attribute between adjacent files in the temporary sequence; updating the display position based on a comparison result obtained from the comparing; and representing visually the weight thereof by varying display contents according to the updating.

A “temporary sequence” may be a temporary order of arrangement for convenience sake, for instance, when displaying on the screen a plurality of files designated by the user. It may simply be a specified sequence, a random sequence or any other sequence decided irrespective of the sizes of values of an attribute. “Temporary display positions” are temporary positions of display on the screen for instance when the user has designated a plurality of files. A state in which objects are displayed in the specified positions is still an initial display state, and the values of an attribute using the concept of weight are not yet represented.

“Adjacent files” are not necessarily strictly adjacent to each other in their sequence. It suffices if the files are located close to each other in an initial display state and the values of their attribute can be compared with each other. As a result of the comparison, the display position of the object for a file whose value is determined larger may be moved downward, or that of the object for file whose value is determined smaller may be moved upward. In this manner, the values of an attribute may be represented for easier visual confirmation by displaying on the screen the process of sorting a plurality of files according to the values of the attribute.

It is to be noted that any arbitrary combination of the above-described structural components and expressions changed between a method, an apparatus, a system, a computer program, a recording medium having stored computer programs therein, a data structure and so forth are all effective as and encompassed by the present embodiments.

Moreover, this summary of the invention does not necessarily describe all necessary features so that the invention may also be sub-combination of these described features.

### BRIEF DESCRIPTION OF THE DRAWINGS

FIG. 1 shows a screen representing values of an attribute related to a plurality of files using a concept of weight according to a first embodiment of the present invention.

FIG. 2 is a block diagram showing functions of a file processing apparatus according to the first embodiment.

FIG. 3 shows a screen displaying objects corresponding to folders.

FIG. 4 shows how objects move from their initial display position to display positions corresponding to their attribute values.

FIG. 5 is a flowchart showing a basic processing flow from folder display to file display in a file processing apparatus.

FIG. 6 illustrates a scene in which the attributes of files to be represented by a concept of weight are switched according to a second embodiment of the present invention.

FIG. 7 is a flowchart showing a process of switching attributes to be displayed on a screen.

FIG. 8 shows an appearance of a PDA in a third embodiment of the present invention.

FIG. 9 shows a state in which a whole PDA is inclined.

FIG. 10 is a functional block diagram of a file processing apparatus according to a third embodiment of the present invention.

FIG. 11 is a flowchart showing a process of changing display contents according to the inclination of a PDA.

FIG. 12 shows a screen representing attribute values using an object which is a balance, according to a fourth embodiment of the present invention.

FIG. 13 is a flowchart showing a process of comparing the sums of data sizes of a plurality of files or folders between themselves.

FIG. 14 shows a dialogue screen from which a user instructs a check on free capacity.

FIG. 15 shows a screen for using a “balance” object to confirm whether free capacity can hold the downloaded files or not.

FIG. 16 shows a screen using a “balloon” object.

FIG. 17 shows a screen display visually representing attribute values by the appearance and display positions of suspension weigher and spherical objects according to a fifth embodiment of the present invention.

FIG. 18 is a flowchart showing a process of measuring the sum of data sizes of a plurality of files or folders.

FIG. 19 shows a screen display visually representing attribute values by a box and “particle” objects placed in a box at random positions.

FIG. 20 is a flowchart showing a process of classifying a plurality of files as detailed step of S16 and S30 of FIG. 5.

FIG. 21 shows a display state where a plurality of particles are placed in a box in ordered positions.

FIG. 22 is a functional block diagram showing a structure of a file processing apparatus according to a seventh embodiment of the present invention.

FIG. 23 is a flowchart showing a process of moving objects, which are a plurality of particles placed in a box, according to attribute values.

FIG. 24 illustrates swaying motions of a PDA in an eighth embodiment of the present invention.

FIG. 25 is a functional block diagram showing a structure of a file processing apparatus according to an eighth embodiment of the present invention.

FIG. 26 is a flowchart showing a process of moving objects, which are a plurality of particles placed in a box, by swaying the whole body of a PDA.

### DETAILED DESCRIPTION OF THE INVENTION

The invention will now be described based on the following embodiments which do not intend to limit the scope of the present invention but exemplify the invention. All of the features and the combinations thereof described in the embodiments are not necessarily essential to the invention.

First Embodiment

In a first embodiment of the present invention, a plurality of files or folders to be managed by a file system are represented by such object forms as spheres or cubes and at the same time the values of an attribute attendant on those files or folders are represented by the weights of those objects. In the real world, where gravitational, buoyant and other forces work, things change their positions according to their “weight”, which is their mass. In other words, the weight of a thing surfaces in the form of a variation in its position. Utilizing this characteristic, the sizes of values of an attribute related to files or folders are visually represented on the screen. In an actual processing, objects corresponding to the files or folders are displayed in positions corresponding to the values of the attribute. As a result, the values of the attribute can be grasped by the positions where the objects are displayed.

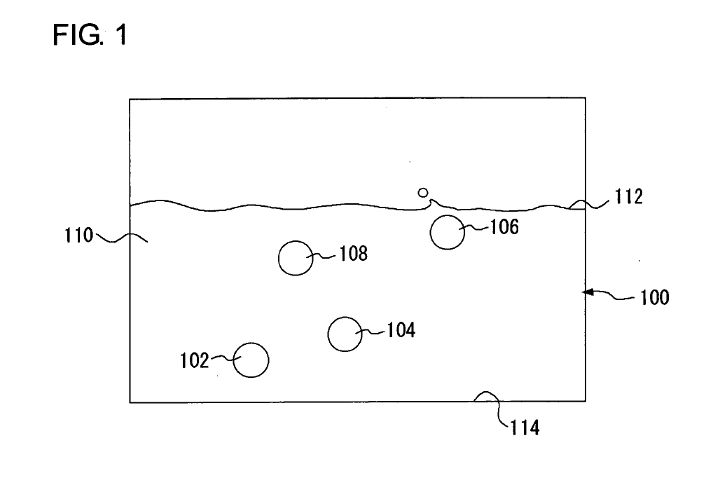

FIG. 1 shows a screen representing the values of an attribute related to a plurality of files using a concept of weight according to the first embodiment. On a screen 100, a plurality of files are displayed as spherical objects. First to fourth spheres 102, 104, 106 and 108 not only represent their respective files but also have the weight corresponding to the data size of their respective files. The first to fourth spheres 102, 104, 106 and 108 are displayed in the water 110.

The first to fourth spheres 102, 104, 106 and 108 are displayed in their relative positions corresponding to their respective weights. For example, the first sphere 102, which is the heaviest, is suspended in the water near the water bottom 114. Conversely, the third sphere 106, which is the lightest, is floating near the water surface 112. The metaphoric relationship of the larger the file size, the heavier the object is conceptually acceptable, and the user can recognize at a glance, without any particular assistance, that a file suspended deeper in the water is of a larger file size.

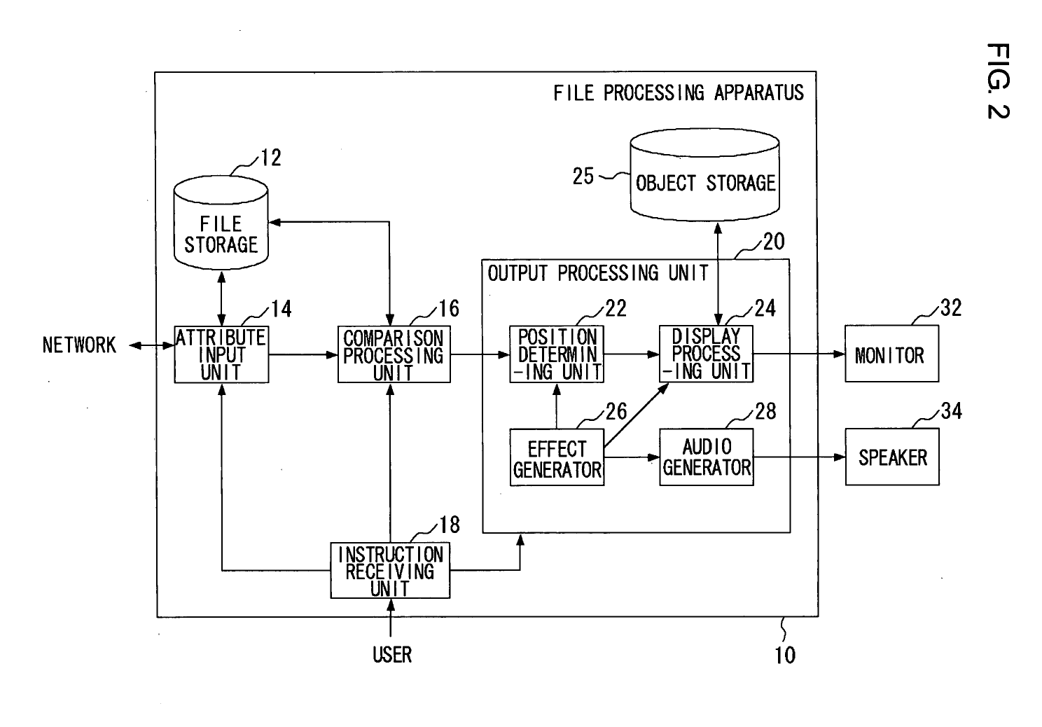

FIG. 2 is a block diagram showing functions of a file processing apparatus according to the first embodiment. In terms of hardware, the file processing apparatus can be realized by a CPU and other elements of a computer. In terms of software, it can be realized by programs having file managing and display processing functions, but drawn and described in FIG. 2 are function blocks that are realized in cooperation with those. Thus, it is understood by those skilled in the art that these functional blocks can be realized in a variety of forms by hardware only, software only or the combination thereof.

The file processing apparatus 10 includes a file storage 12 for storing a plurality of files and folders, an attribute input unit 14 for receiving attribute values of files, a comparison processing unit 16 for comparing the attribute values, and an instruction receiving unit 18 for receiving instructions from a user. The file storage 12 may be constituted by an auxiliary storage, such as a hard disk on which a plurality of files or folders are stored under the management of a file system or a memory device, such as a detachable non-volatile memory.

The attribute input unit 14 receives attribute values of files or folders selected by the user from the file storage 12 or a node of a network. In this first embodiment, data sizes of selected files are received. The comparison processing unit 16 compares the data size of the selected file with a reference value. The reference value may be a predetermined numerical value corresponding to the water surface 112 or the bottom 114 of the water shown in FIG. 1. For example, the data size corresponding to the water surface 112 may be set to zero bytes, and the data size corresponding to the water bottom 114 may be set to the maximum data size of the files held in the file storage 12. Suppose that the maximum data size is 10 MB and the data size of a selected file is 5 MB, then the file is displayed in a middle position between the water surface 112 and the bottom 114 of the water. When a plurality of files are to be selected, the data size of any one of them may be set as the reference value.

The file processing apparatus 10 further includes an output processing unit 20 for generating images and audio and an object storage 25 for storing image data or three-dimensional data of each object. To be connected to the file processing apparatus 10 are a monitor 32 for displaying images on the screen and a speaker 34 for outputting audio. The object storage 25 may be formed integrally by a single storage unit that also serves as the file storage 12. The output processing unit 20 includes a position determining unit 22 for setting the display positions of objects, a display processing unit 24 for outputting images to the monitor 32, an audio generator 28 for outputting audio to the speaker 34, and an effect generator 26 for changing images or audio.

The position determining unit 22 sets a relative display position of an object for a file selected by the user based on the results of comparison by the comparison processing unit 16. When a plurality of files have been selected, the position determining unit 22 sets relative display positions respectively for them. For example, the position of the heaviest file of the plurality of files is set to the water bottom 114, the position of the lightest file of the plurality of files is set to the water surface 112, and the relative positions of the other files are determined between the water bottom 114 and the water surface 112.

The display processing unit 24 acquires image data or three-dimensional data necessary for the display of spheres or cubes from the object storage 25 and displays them in their relative positions set on the screen 100. The display processing unit 24 displays an image of the water 110 as the background. When a plurality of files have been selected, the display processing unit 24 represents a comparison of their weights by displaying the spheres in their relative positions. To show how the spheres are adrift in the water, the display processing unit 24 may move the objects up and down and right and left in the display. In this case, the objects are moved vertically or horizontally within a range of a few pixels around their respective display positions set by the position determining unit 22.

The instruction receiving unit 18 may receive instructions from the user intending to change the display positions of objects. In such a case, the effect generator 26 causes the position determining unit 22 and the display processing unit 24 to carry out a processing to effect the change to the position of the object based on the user instructions. The instruction receiving unit 18 receives instructions from the user via a control device, such as a mouse or keyboard of a PC or a controller of a game machine. The effect generator 26 determines an object which is to be changed, and calculates the amount of change therefor according to the instructions received by the instruction receiving unit 18 and then sends the results to the position determining unit 22 and the display processing unit 24.

For example, when the user instructs that a motion of a sphere thrown into the water be displayed, the effect generator 26 specifies the sphere for which the display must be changed, and the position determining unit 22 sets a range for the motion of the sphere such that a motion of the sphere dropping into the water and sinking can be displayed. And the display processing unit 24 displays images of a splash, ripples and the like that may accompany such a motion. The motion contents are also conveyed from the effect generator 26 to the audio generator 28, which outputs sounds corresponding to the motion to the speaker 34. The audio generator 28 may produce sounds, using volumes and tones that correspond to the weight of the sphere, namely, the data size of the file.

For example, if the user instructs that the water be stirred or a sphere be flipped, the position determining unit 22 and the display processing unit 24 will perform a necessary processing to display images of the sphere being swayed up and down or right and left and the water surface 112 undulating. In this case, too, the motion contents are conveyed from the effect generator 26 to the audio generator 28, which produces necessary sounds.

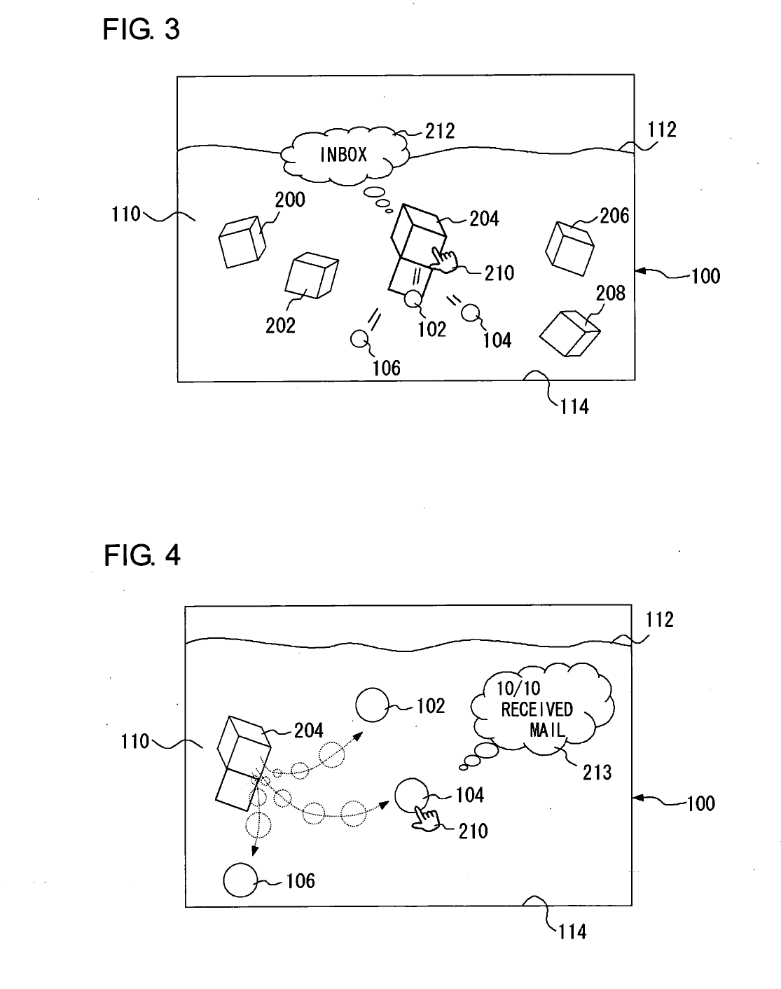

FIG. 3 shows a screen displaying objects corresponding to folders. In the present embodiment, folders are represented by cubic objects to be distinguished in appearance from files represented by spheres. Displayed on a screen 100 are how first to fifth cubes 200, 202, 204, 206 and 208 are adrift in the water 110. These cubes are displayed in relative positions between the water surface 112 and the water bottom 114 corresponding to their respective attribute values. The appearances of these cubes are defined by three-dimensional data, and the display processing unit 24 displays the cubes rotating little by little so that the faces thereof change their orientation with time.

When the user selects the third cube 204 via the instruction receiving unit 18, a folder name 212 is displayed on the screen 100. Here, a character string “INBOX” is displayed as the folder name 212. Now the user gives instructions to open the third cube 204 via the instruction receiving unit 18, and the display will show the third cube 204 opening and releasing first to third spheres 102, 104 and 106 from within it. The first to third spheres 102, 104 and 106 represent the files contained in the folder represented by the third cube 204.

FIG. 4 shows how objects move from their initial display position to the display positions corresponding to their attribute values. The first to third spheres 102, 104 and 106, which have been released from the third cube 204 shown in FIG. 3, move to the relative display positions corresponding to their respective data sizes. The trajectories thereof are calculated by the position determining unit 22. When the user selects the second sphere 104 via the instruction receiving unit 18, a file name 213 is displayed on the screen 100. Here, a character string “10/10 RECEIVED MAIL” is displayed as the file name 213.

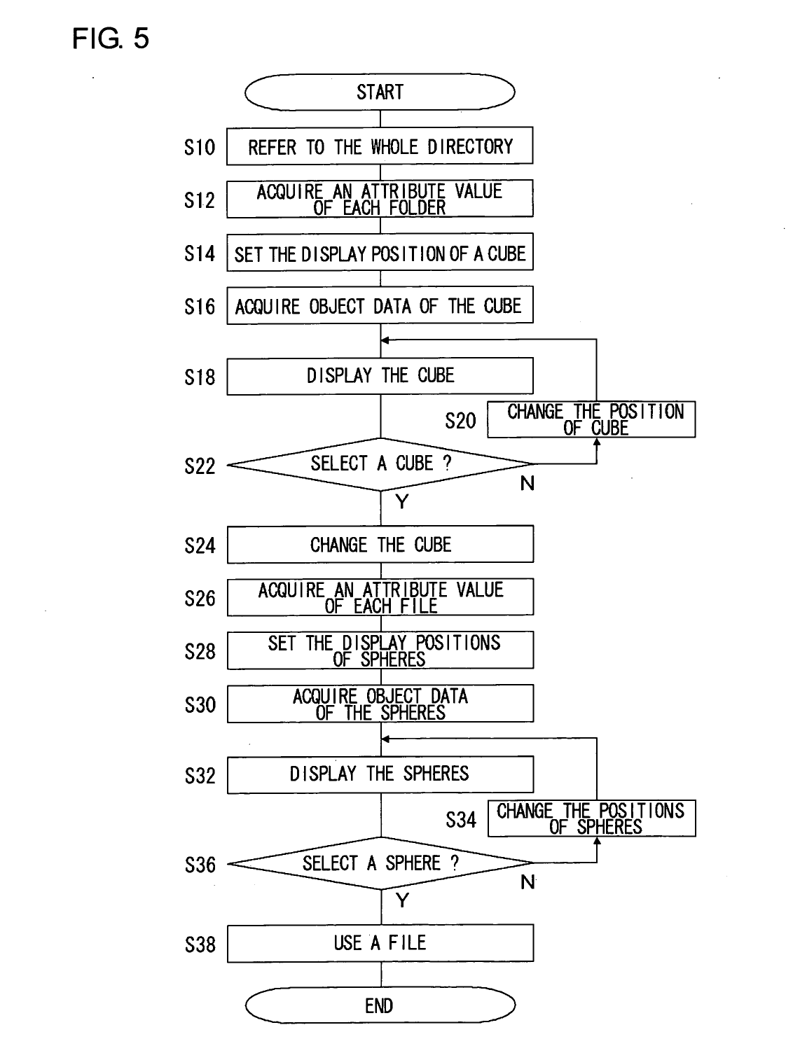

FIG. 5 is a flowchart showing a basic processing flow from folder display to file display in the file processing apparatus 10. The attribute input unit 14 refers to the whole directory in the file storage 12 (S10) and acquires an attribute value of each folder (S12). According to the present embodiment, the data size of each folder is acquired. The position determining unit 22 sets the display position of a cube for each folder according to the acquired data size (S14). The display processing unit 24 acquires object data, such as image or three-dimensional data on each cube, from the object storage 25 (S16) and displays it in the position set by the position determining unit 22 (S18).

Until the user selects any of the cubes via the instruction receiving unit 18 (S22N), the display processing unit 24 keeps displaying the cubes while the orientation and position of the faces thereof change little by little (S20). When the user selects one of the cubes and instructs the opening thereof (S22Y), the display processing unit 24 displays the process of the cube releasing the spheres (S24). The attribute input unit 14 acquires the attribute value of each file contained in the folder of the opening cube (S26), and the position determining unit 22 sets the display positions of the spheres according to the attribute value of each file (S28).

The display processing unit 24 acquires object data on the spheres from the object storage 25 (S30) and display them near the selected cube, which are their initial positions (S32). The position determining unit 22 generates the trajectories to the set display positions and the display processing unit 24 displays the process of the spheres moving along the trajectories to the set display positions. Until the user selects any of the spheres (S36N), the spheres adrift and swaying in the water is displayed (S34). The user selects one of the spheres (S36Y) and uses it in such a way as opening the file (S38).

By implementing the above structure, data sizes of files or folders are represented using a concept of weight. By presenting files and folders in a display method that appeals to intuitive perception, a graphical file browser is realized.

Second embodiment

A second embodiment of the present invention has a function of switching by user instructions the attributes of files or folders which are to be represented by a concept of weight. Otherwise, the structure and functions thereof are the same as those of the first embodiment.

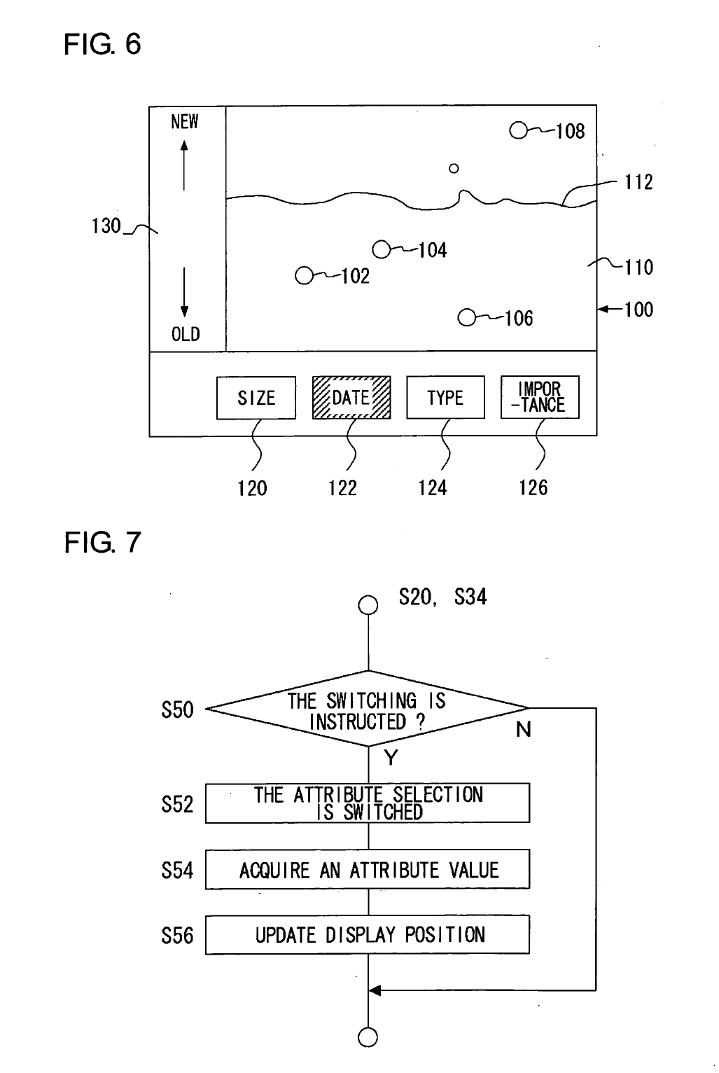

FIG. 6 illustrates a scene in which the attributes of files to be represented by a concept of weight are switched according to the second embodiment. On a screen 100, the user selects an attribute by pressing one of Size button 120, Date button 122, Type button 124 and Importance button 126. When selecting the data size of files or folders as the attribute as in the first embodiment, click on the Size button 120. When selecting the date and time of data preparation or updating, click on the Date button 122. When selecting the type of files or folders, click on the Type button 124. When selecting the importance of files or folders determined arbitrarily by the user, click on the Importance button 126.

FIG. 6 shows a state in which the Date button 122 has been selected. At this time, a level display 130 corresponding to the type of button selected appears on the left side of the screen 100. The level display 130 shows visually the correspondence of older dates with heavier weights and newer dates with lighter weights, so that an old or new date of preparation may be grasped at a glance by seeing how far a sphere sinks in the water. Referring to FIG. 6, it can be easily grasped visually that a third sphere 106 is the oldest file and a fourth sphere 108 is the newest file.

Similarly, when the Type button 124 has been selected, the spheres are displayed in depth positions predetermined according to the types of the files. The relationship between the types of files and the weights is indicated by the level display 130. When the Importance button 126 is selected, the spheres for files with greater importance are displayed in positions of deeper submersion.

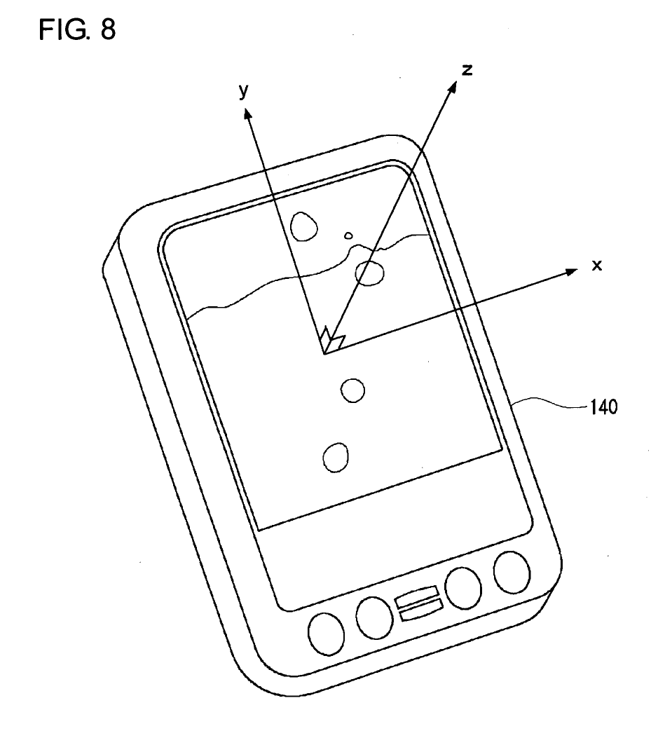

FIG. 7 is a flowchart showing a process of switching attributes to be displayed on the screen. A basic processing flow in a file processing apparatus 10 according to the second embodiment is as shown in FIG. 5. FIG. 7 represents a flow to be replaced with S20 and S34 of FIG. 5. When user instructions to switch attributes are received via the instruction receiving unit 18 (S50Y), the attributes to be represented by weight are switched according to the instructions (S52). The attribute input unit 14 acquires the attribute values after the switching (S54), and the position determining unit 22 updates the display positions of the objects according to the acquired values (S56).

Third Embodiment

A file processing apparatus 10 according to a third embodiment of the present invention is a PDA. FIG. 8 shows an appearance of the PDA. On the screen of a PDA 140, too, the values of an attribute concerning files or folders are represented by the weight of spheres thrown into the water. Since the screen of a PDA is relatively small, a display of multiple character strings cannot be grasped at a glance. Thus, it helps intuitive recognition better if the attribute values for the files or folders are represented by the weights of objects rather than by character strings.

This PDA 140 has a built-in tilt sensor, and the positions of the objects change according to the inclination of the body of the PDA 140. Thus, files may be controlled by operating the PDA 140 with one hand. If the screen of the PDA 140 is an x-y plane and an axis vertical to this plane is a z-axis, then the angle between the z-axis and the horizontal plane is the inclination of the PDA 140.

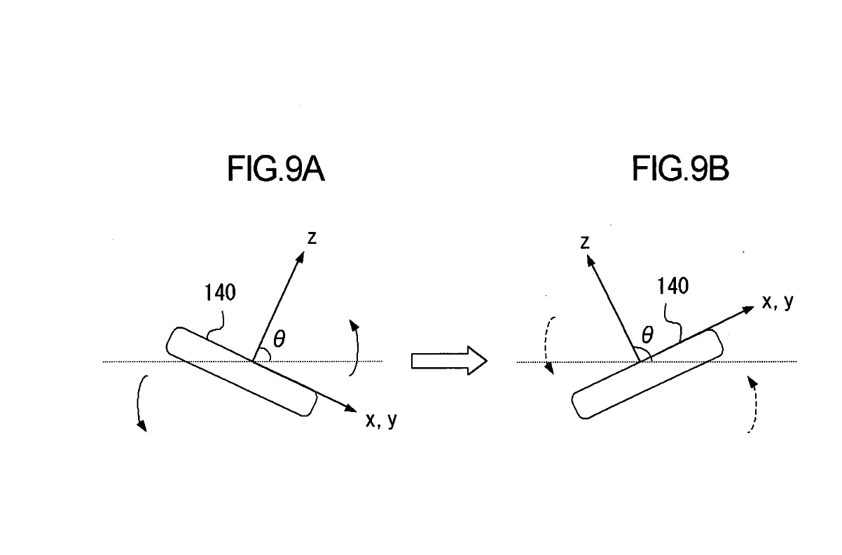

FIG. 9 shows a state in which the whole PDA 140 is inclined. That is, from a state as shown in FIG. 9A, one end of the PDA 140 is inclined downward and the other end thereof upward into a state as shown in FIG. 9B. A sensor detects an angle θ between the z-axis and the horizontal plane as the inclination of the PDA 140, and when the inclination exceeds a predetermined threshold value, the spheres in the water displayed on the screen of the PDA 140 change their positions. When the inclination is in the x-axis direction, the spheres move in the x-axis direction, and when the inclination is in the y-axis direction, they move in the y-axis direction.

Where the inclination does not exceed the threshold value, buoyancy is assumed to be working in the z-axis direction and the spheres are displayed in such a manner that they are adrift in random directions in the x-y plane. For the first time when the inclination has exceeded the threshold value, the difference in weight is represented by a move in the y-axis direction. When the inclination changes in the x-axis direction, the display may, for instance, be produced in such a way that the screen scrolls to the left or to the right. When not all of a plurality of spheres selected by the user fall within the screen, the area to be displayed may be switched by scrolling the screen rightward or leftward. Through an operation like this, the user can either display or not display on the screen certain spheres from among the plurality of spheres, thus selecting a desired sphere, or a file.

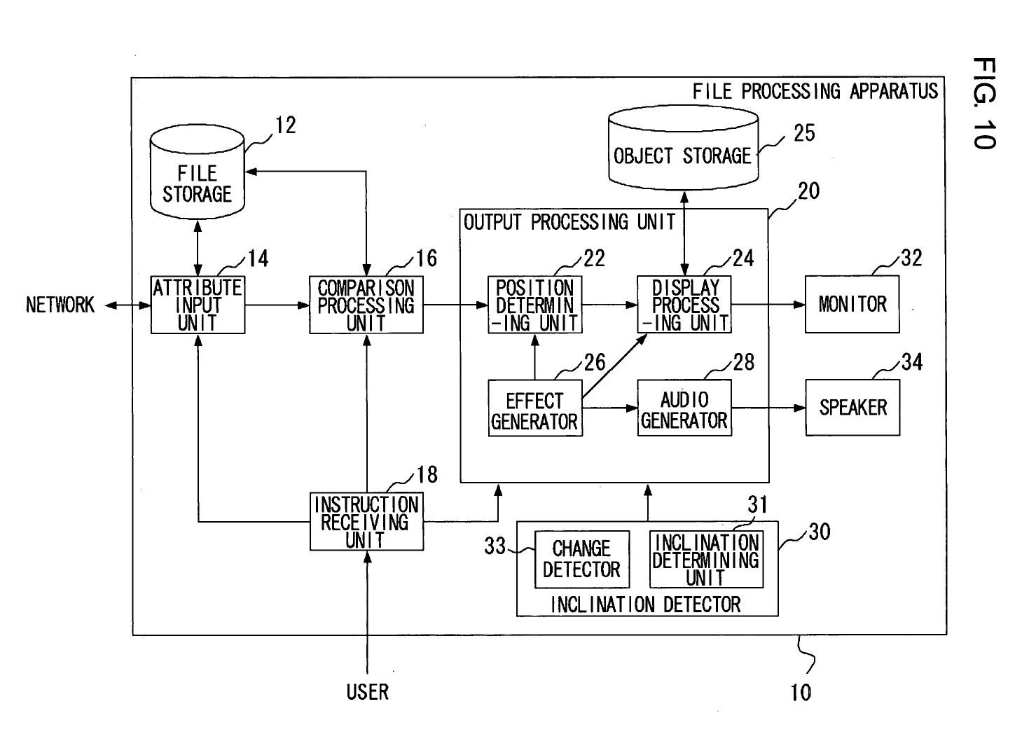

FIG. 10 is a functional block diagram of a file processing apparatus 10 according to the third embodiment. This third embodiment differs from the first embodiment in that the file processing apparatus 10 includes an inclination detector 30 for detecting its inclination and that it has a monitor 32 and a speaker 34 built-in. The inclination detector 30 includes a change detector 33 for detecting the magnitude of inclination of a PDA 140 as a whole, which is a file processing apparatus 10 operated by the user, and an inclination determining unit 31 for determining the direction of the inclination. The inclination detector 30 may be structured in such a manner that it is detachable from the file processing apparatus 10. When the change detector 33 has detected an inclination surpassing the threshold value, a position determining unit 22 updates the relative display positions for the objects according to the direction of the inclination.

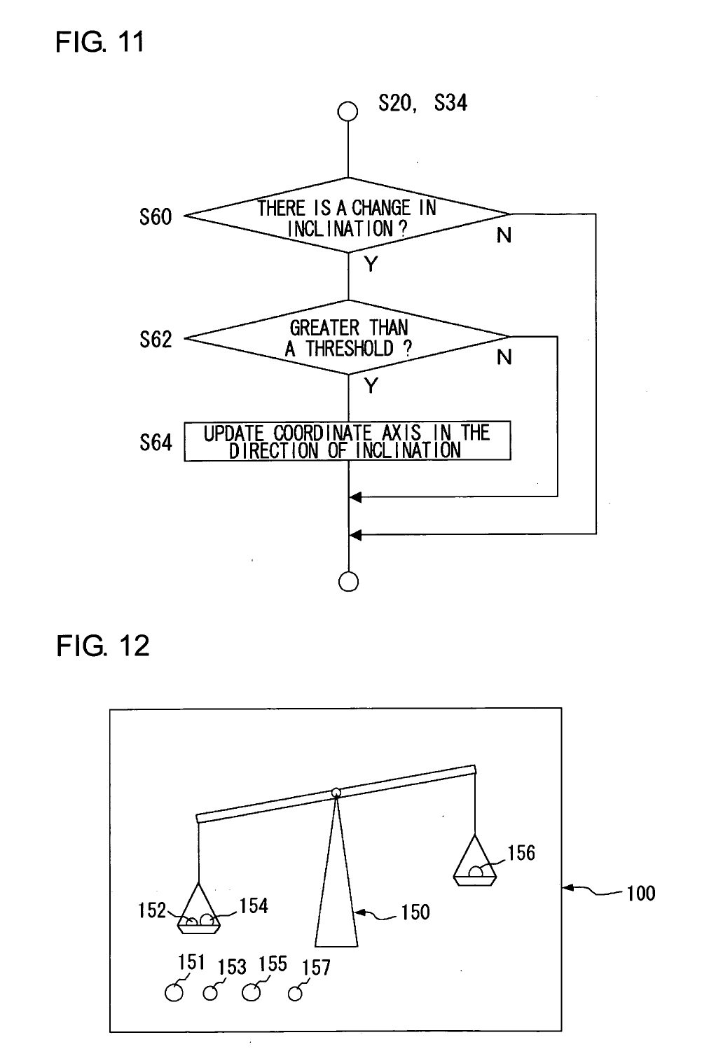

FIG. 11 is a flowchart showing a process of changing display contents according to the inclination of the PDA 140. A basic processing flow in the file processing apparatus 10 according to the third embodiment is as shown in FIG. 5. FIG. 11 represents a flow to replace S20 and S34 of FIG. 5. When the user inclines the PDA 140 (S60Y) and the inclination exceeds a predetermined threshold value (S62Y), the position determining unit 22 updates the display positions along the coordinate axis in the direction of the inclination (S64).

Fourth Embodiment

In a fourth embodiment of the present invention, the values of an attribute concerning files or folders are represented in such a manner that a comparison is made using another object besides the objects representing the attribute values themselves. Another object meant here is a balance for instance, which may change in form or position according to the balance of weight of a plurality of objects to be compared.

FIG. 12 shows a screen display representing the attribute values, using another object, namely, a balance. A first sphere 152 and a second sphere 154 are placed on the left-hand scale plate of the balance 150. A third sphere 156 is placed on the right-hand scale plate of the balance 150. The first to third spheres 152, 154 and 156 represent their respective files or folders. In this illustration, the left-hand scale plate is hanging lower with heavier objects on, so that it can be seen at a glance that the sum of the files represented by the first and second spheres 152 and 154 have a larger data size than the file represented by the third sphere 156.

The user may set a new file or folder to be compared by adding any of fourth to seventh spheres 151, 153, 155 and 157 on the left-hand scale plate or the right-hand scale plate of the balance 150. Thus, in this fourth embodiment, a sum of data sizes of files or folders may be compared with the data size of another file or folder. Moreover, by placing a plurality of spheres on each of the scale plates, the sums of data sizes of files or folders may be compared with each other. Comparison of weights of objects among themselves is processed by the comparison processing unit 16 of FIG. 2. The positions of objects are calculated by the position determining unit 22, and the images to be displayed are processed by the display processing unit 24.

Any of the spheres may be utilized as an object to show the size of free area rather than the data size of a file or folder. For example, the third sphere 156 may be used to represent the size of free area in the total memory capacity of the file storage 12. In such a case, it can be easily seen from FIG. 12 that the files or folders represented by the first and second spheres 152 and 154 cannot be stored in the file storage unit 12 because it can be easily grasped that their data size surpasses the capacity of the file storage unit 12.

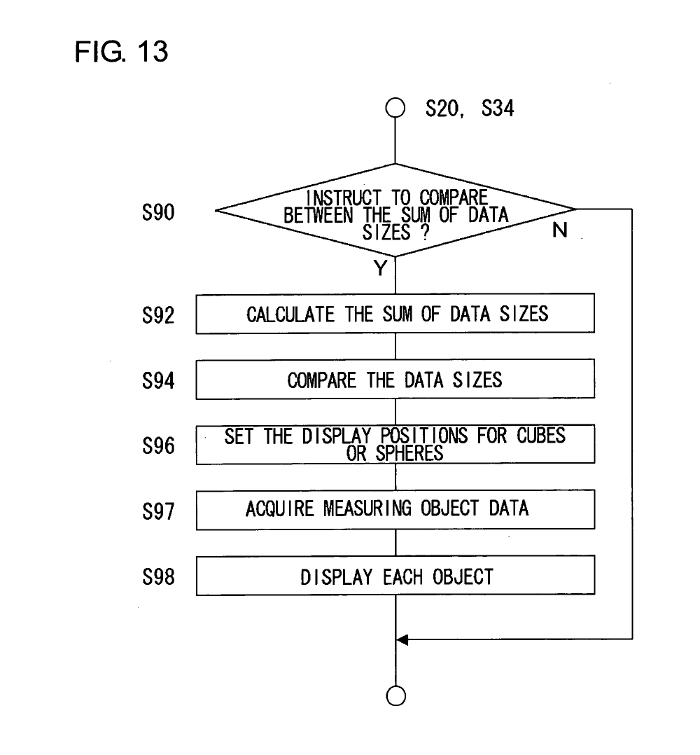

FIG. 13 is a flowchart showing a process of comparing the sums of data sizes of a plurality of files or folders between themselves. A basic processing flow in a file processing apparatus 10 according to the fourth embodiment is as shown in FIG. 5. FIG. 13 represents a flow to replace S20 and S34 of FIG. 5.

When the user instructs via the instruction receiving unit 18 that a comparison be made between data sizes of combinations of a plurality of files or folders (S90Y), the sum of data sizes for one of the combinations to be compared is calculated (S92) and the thus calculated sum is compared with the data size of the other combination (S94). According to the result of this comparison, the position determining unit 22 sets the display positions for the spheres (S96). The display processing unit 24 acquires object data on the balance from the object storage 25 as measuring objects (S97) and displays the balance and the plurality of spheres on the screen (S98).

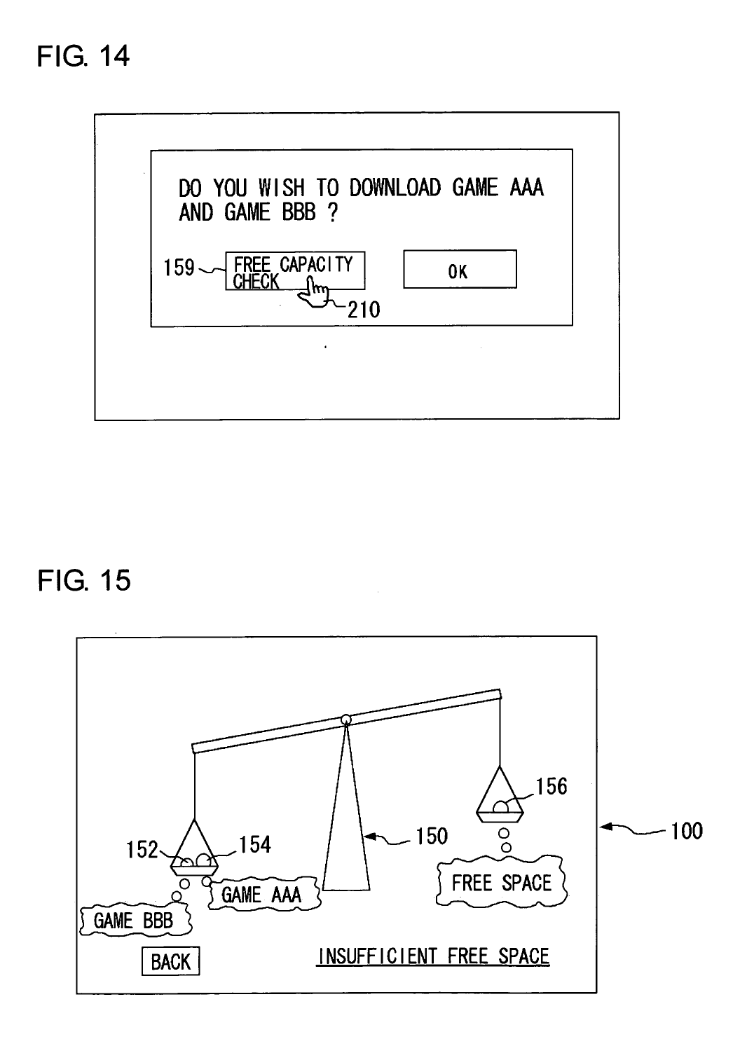

FIG. 14 shows a dialogue screen from which the user instructs a check on free capacity. When the user downloads a desired file from a network, the balance object of this fourth embodiment may be used as an interface for confirming whether the data size of the file can be locally stored or not. On this screen, the user who is about to download files named “Game AAA” and “Game BBB” from a network is now being asked to perform a free capacity check. Upon a click on a Check button 159 by the user operating a pointer 210, the screen will switch to a screen as shown in FIG. 15.

FIG. 15 shows a screen for using a “balance” object to confirm whether free capacity can hold the downloaded files or not. On this screen, first and second spheres 152 and 154 representing the files to be downloaded are placed on the left-hand scale plate of the balance, and a third sphere 156 representing the free capacity is placed on the right-hand scale plate of the balance. In this illustration, the left-hand scale plate is hanging lower with heavier objects on, so that it can be seen at a glance that the data size of the files to be downloaded is larger than the free capacity. Further, the names of the files and a character string, “Free Space”, may be displayed near the respective spheres.

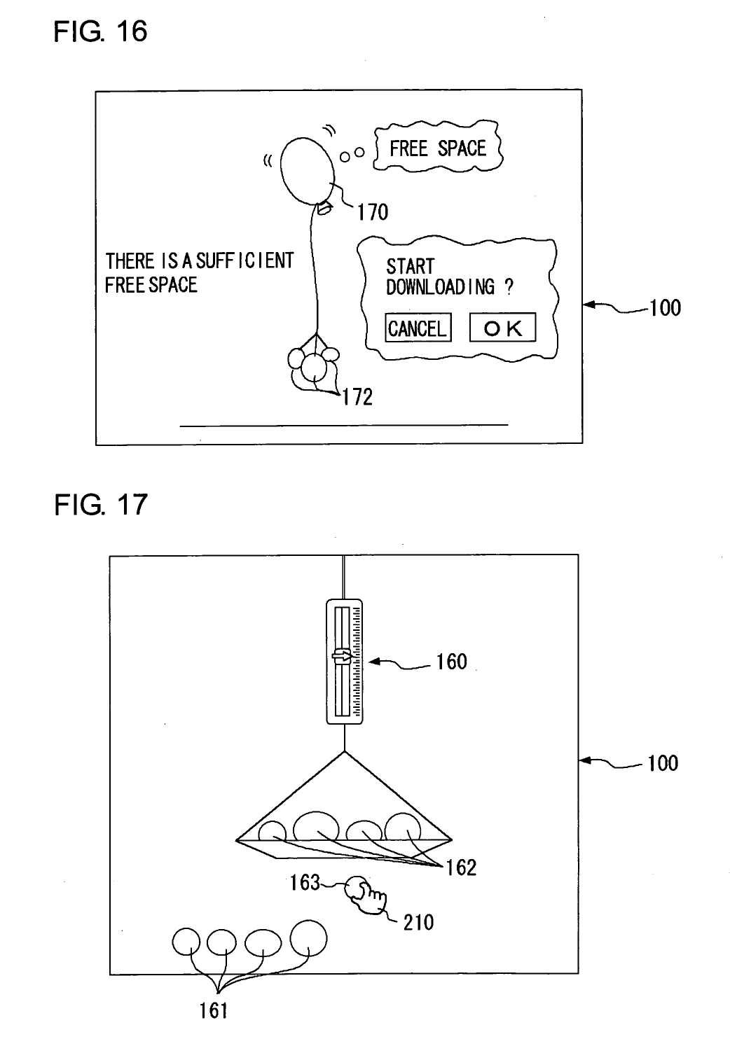

FIG. 16 shows a screen using a “balloon” object as an interface with similar functions as the “balance” object in FIG. 15. Another object meant here is a balloon with spheres hanging from it, which changes its position according to the balance of buoyancy and gravity. If gravity is a weight in the positive direction, buoyancy is a weight in the negative direction. The screen in FIG. 16 displays a state in which a plurality of spheres 172 representing a plurality of files, respectively, are suspended with a string below a balloon 170. The plurality of spheres 172 show in terms of weight the data size of a file or folder selected by the user. If the user selects a plurality of files or folders, then the total of their data sizes will be shown as the total weight. The plurality of spheres 172 are suspended in the air by the buoyancy produced by the gas inside the balloon 170.

The buoyancy of the balloon 170 indicates the size of free capacity in the file storage 12 in the negative direction. If the data size of a file or folder to be measured is small enough to go into the free capacity, the display thereof will be such that the plurality of spheres 172 are lifted up from the ground by the balloon 170. Conversely, if the data size of a file or folder is larger than the free capacity, then the display will show the plurality of spheres 172 stuck to the ground. In this manner, a visual representation using a “balance” or “balloon” object is made for the user so that prior to starting downloading, the user can easily see whether or not the free capacity can accommodate the file or folder to be downloaded. Also, this visual simulation for proper selection can be used to easily find which combination of files can be stored before starting to download them.

When the free capacity is confirmed, downloading is started based on user instructions. A user command therefor may be given either by a dialogue screen as shown in FIG. 14 that prompts the start of downloading or a command for action, such as the user's bursting the balloon 170. When the balloon has burst, the position determining unit 22 and the display processing unit 24 carry out such processing as to display the motion of the suspended spheres dropping to the ground. Moreover, the balloon bursting may be displayed for instance when a non-volatile memory is removed from this apparatus to record a file or folder.

Fifth Embodiment

In a fifth embodiment of the present invention, the values of an attribute concerning files or folders are represented in such a manner that measuring is done using still another object besides the objects representing the attribute values themselves. Still another object meant here is a suspension weigher for instance, which may change in form or position according to the weight measured of selected objects. Use of a suspension weigher may also allow the user to read the specific value of the weight.

FIG. 17 shows a screen display visually representing the attribute values by the appearance and display positions of the suspension weigher and spherical objects. A plurality of first spheres 162 are placed on the scale plate of a suspension weigher 160. These spheres represent their respective files or folders, and the weight measured by the suspension weigher 160 represents the total of the data sizes of these files or folders. Since a plurality of spheres may be placed on the scale plate, the sum of a plurality of files or folders can be handled in this fifth embodiment.

Changes in the position of the first spheres 162, the scale reading of the suspension weigher 160, and the form or appearance image of the suspension weigher 160 are processed by the position determining unit 22 and the display processing unit 24 of FIG. 2. The user moves a second sphere 163 onto the scale plate by operating a pointer 210 on the screen. The user may also add an object to be measured from among a plurality of third spheres 161. Instructions to increase or decrease the number of spheres are given by moving the pointer 210.

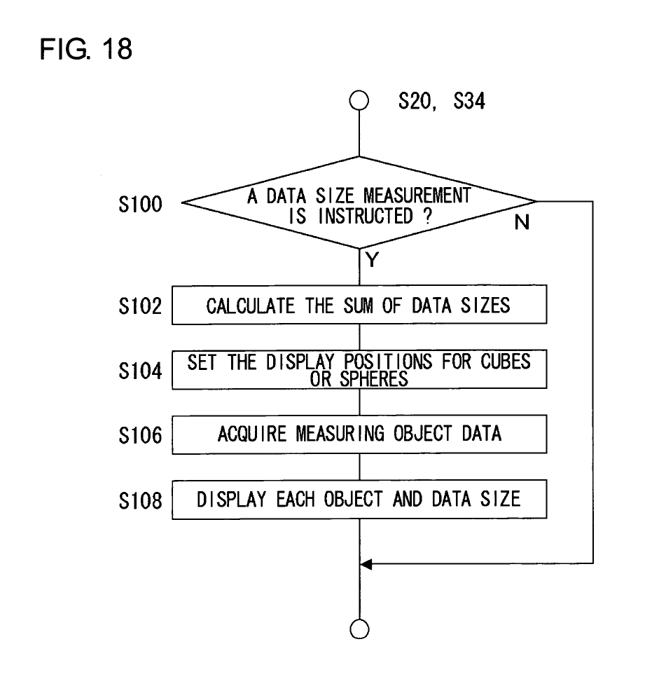

FIG. 18 is a flowchart showing a process of measuring the sum of data sizes of a plurality of files or folders. A basic processing flow in a file processing apparatus 10 according to the fifth embodiment is as shown in FIG. 5. FIG. 18 represents a flow to replace S20 and S34 of FIG. 5.

When the user instructs a data size measurement (S100), the attribute input unit 14 calculates the sum of data sizes of files or folders represented by the spheres placed on the scale plate (S102). According to the result of this calculation, the position determining unit 22 sets the display positions for the spheres (S104). The display processing unit 24 acquires object data on the suspension weigher from the object storage 25 as measuring objects (S106) and not only displays this data and the spheres in the predetermined positions but also indicates the calculated sum of data sizes on the scale (S108).

Sixth Embodiment

In a sixth embodiment of the present invention, the values of an attribute concerning files or folders are represented in such a manner that classification is done using still another object besides the objects representing the attribute values themselves. Still another object meant here is a box for instance, which the user can intuitively associate with a folder. Moreover, files or folders to be classified are represented by particles placed in a box. In this sixth embodiment, too, the data size which serves as an attribute value is shown in terms of weight.

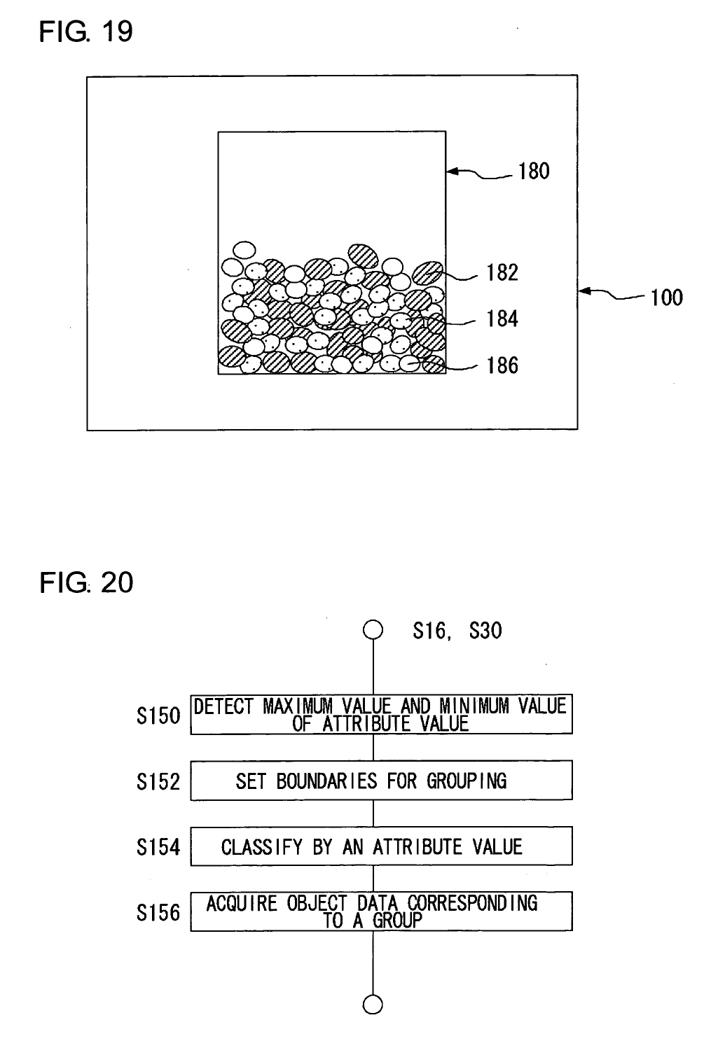

FIG. 19 shows a screen display visually representing the attribute values by a box and “particle” objects. A plurality of particles representing files or folders to be classified are placed in a box 180. These particles are divided into three appearance types according to their respective weights. A first particle 182 is a file of relatively large data size, whereas a third particle 186 is a file of relatively small data size. A second particle 184 has a data size in between them. As shown in FIG. 19, the plurality of particles placed in the box 180 are displayed in random arrangement. In this manner, a rough visual classification is made of the files contained in a specific folder. The classification meant here need not be highly accurate but serves its purpose if the user can grasp a rough classification at a glance. The objects in this sixth embodiment are classified into three pattern types, but any colors or patterns or the like may be used so long as they effect a rough classification.

A file processing apparatus 10 according to this sixth embodiment has a structure similar to the one shown in FIG. 2 of the first embodiment. The comparison processing unit 16 in FIG. 2 classifies a plurality of files into a plurality of groups according to their respective sizes of attribute values. The display processing unit 24 acquires “appearance” object data on the groups from the object storage 25 and displays the objects.

FIG. 20 is a flowchart showing a process of classifying a plurality of files as detailed steps of S16 and S30 of FIG. 5. In this sixth embodiment, a plurality of files are roughly classified into three groups, which are then distinguished in appearance by their respective colors and patterns. The classification is made using the following procedure, for instance. First, the comparison processing unit 16 detects a maximum value and a minimum value from each of the attribute values of the files (S150). The range from the maximum value to the minimum value is divided into a plurality of ranges, such as three ranges, and the boundaries of the respective ranges are set as the boundaries for grouping (S152). The division may be into equal parts or any other way under predetermined rules. A plurality of files are thus classified into three groups by comparing an attribute value of each file with the boundary values (which correspond to “a reference value” in WHAT IS CLAIMED of this patent specifications) (S154). After this grouping according to the attribute values, the display processing unit 24 acquires object data on each of the groups from the object storage 25 (S156).

If file types or file creators as attribute values are to be represented by weight, a plurality of files may be grouped by file type or file creator. Moreover, for example, when the attribute values represent dates and times, such as the dates and times of file preparation or updating, the values of the oldest and the newest dates and times may be detected from the attribute values of the files at S150.

Seventh Embodiment

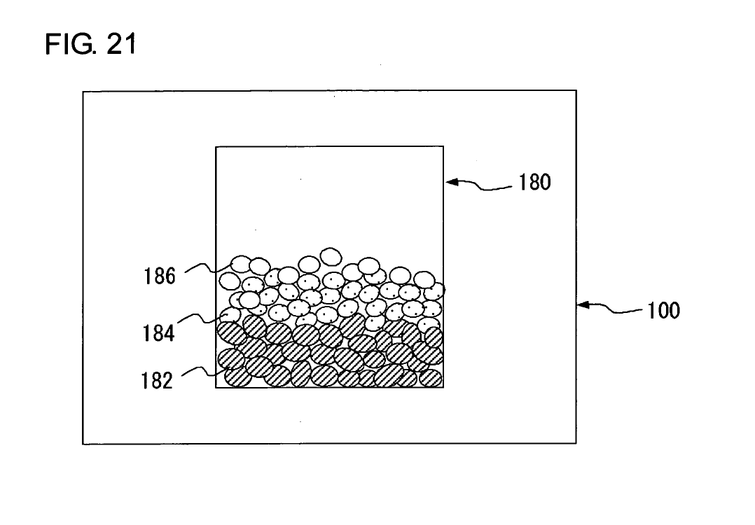

In a seventh embodiment of the present invention, the values of an attribute concerning files or folders are represented by particles placed in a box just as in the sixth embodiment. In this seventh embodiment, too, the data size, or an attribute value, is shown in terms of weight and at the same time each particle is displayed in a position corresponding to its weight. Initially, the particles are displayed temporarily in random positions as shown in FIG. 19. Then the positions of accumulation of the particles are changed according to their weights and the particles are visually classified by the position of accumulation as shown in FIG. 21. In FIG. 19 and FIG. 21, the particles are classified in three appearance types, for convenience, just as in the sixth embodiment, but it goes without saying that any other examples with different modes of classification can also be used.

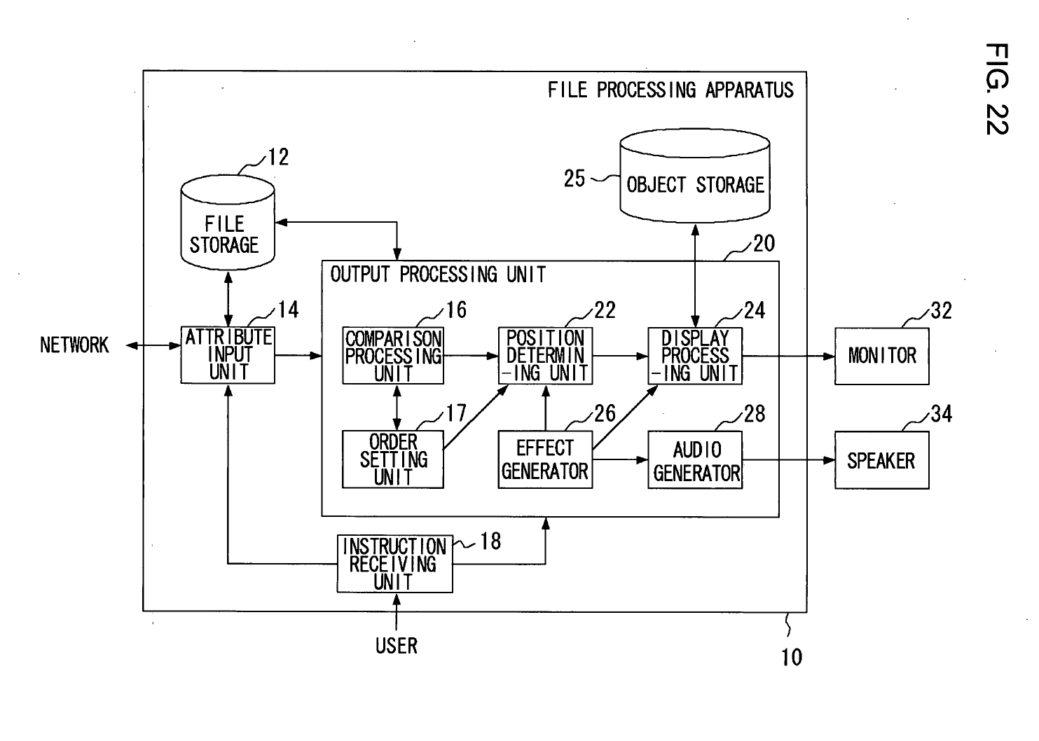

FIG. 22 is a functional block diagram showing a structure of a file processing apparatus 10 according to the seventh embodiment. An output processing unit 20 in this seventh embodiment differs from the first to sixth embodiments in that it includes a comparison processing unit 16 and an order setting unit 17. The order setting unit 17 sets a temporary order for a plurality of files to be classified. This temporary order, which is determined without regard to the values of an attribute concerning the plurality of files, may be either a random order or an order selected by the user. In the temporary order, the position determining unit 22 determines temporary display positions for the plurality of files and the display processing unit 24 displays the “particle” objects in the temporary display positions.

The comparison processing unit 16 compares attribute values for adjacent files in the temporary order. Adjacent files meant here may not have to be strictly adjacent, but may be a plurality of files selected arbitrarily. In effect, a plurality of files are classified into a plurality of small groups, and the attribute values are compared group by group sequentially. Based on the results of the comparison, the order setting unit 17 updates the order of the plurality of files. For example, when the order of a plurality of files is to be updated in an ascending order of the attribute values thereof, the order will be reversed if a file which is behind another file in order has a smaller attribute value than the other.

As the above-described updating of sequence between adjacent files is repeated, the order as a whole is arranged into an ascending order with the results of group-by-group comparison reflected in it gradually. This process of updating the order, which applies the principle of rearrangement by bubble sort, is displayed progressively on the screen. Thus, the user can visually grasp how a plurality of particles are gradually being classified according to their weights. The visual changes in the display are processed by an effect generator 26, the position determining unit 22 and the display processing unit 24.

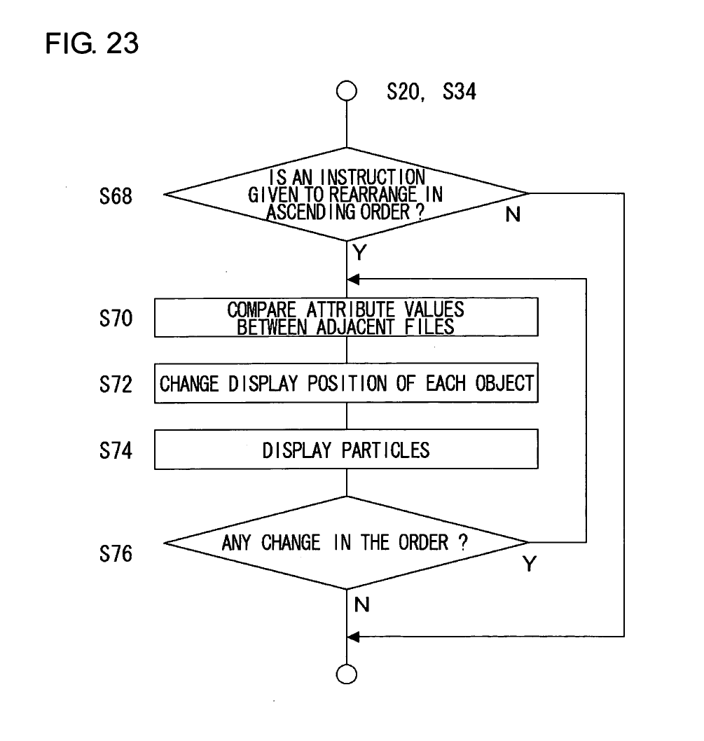

FIG. 23 is a flowchart showing a process of moving objects, which are a plurality of particles placed in a box, according to attribute values. A basic processing flow in a file processing apparatus 10 according to this seventh embodiment is as shown in FIG. 5. FIG. 23 represents a flow to replace S20 and S34 of FIG. 5. At S14 and S28 in FIG. 5, the order setting unit 17 determines a temporary order and the position determining unit 22 sets temporary display positions in the temporary order. At S18 and S32, the objects are displayed temporarily. In FIG. 23, when instructions are given to rearrange in an ascending order (S68), the comparison processing unit 16 compares the attribute values between adjacent files in a temporary order and the order setting unit 17 updates the order based on the results of comparison (S70). In the updated order, the position determining unit 22 changes the display position of each object (S72) and the display processing unit 24 displays the particles in their respective positions (S74). S70 to S74 are repeated until there is no longer order change (S76).

Eighth Embodiment

A file processing apparatus 10 according to an eighth embodiment of the present invention is realized as a PDA 140. The user can instruct a box 180 to sway by swaying the whole body of the PDA 140. In response to the sway, a plurality of files, represented by particles, are classified into groups.

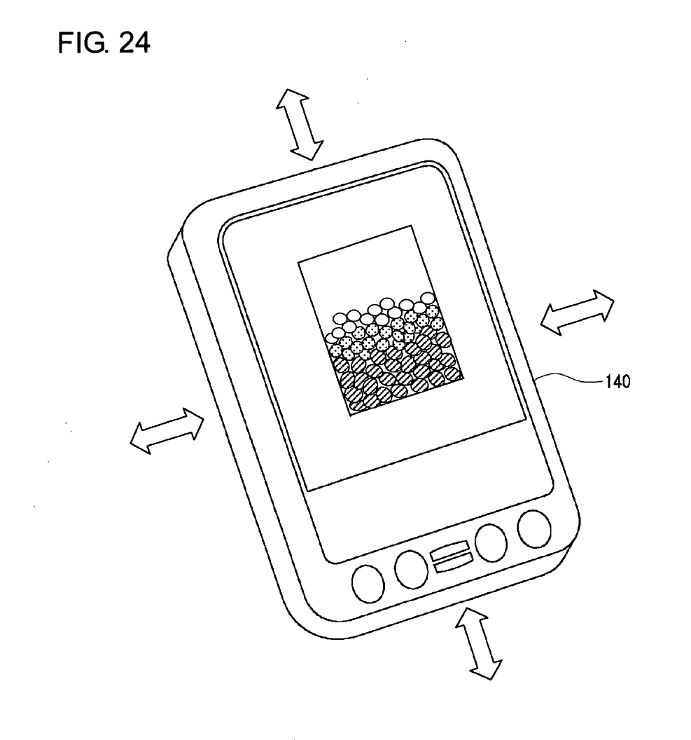

FIG. 24 illustrates the swaying motions of a PDA 140. The user can sway the whole PDA 140 up and down or right and left relative to the screen. The PDA 140, which has a built-in vibration sensor, detects the magnitude of sway. Whenever a sway is detected, the display positions for the particles are updated gradually, with the particles moving to the positions of accumulation according to their data sizes.

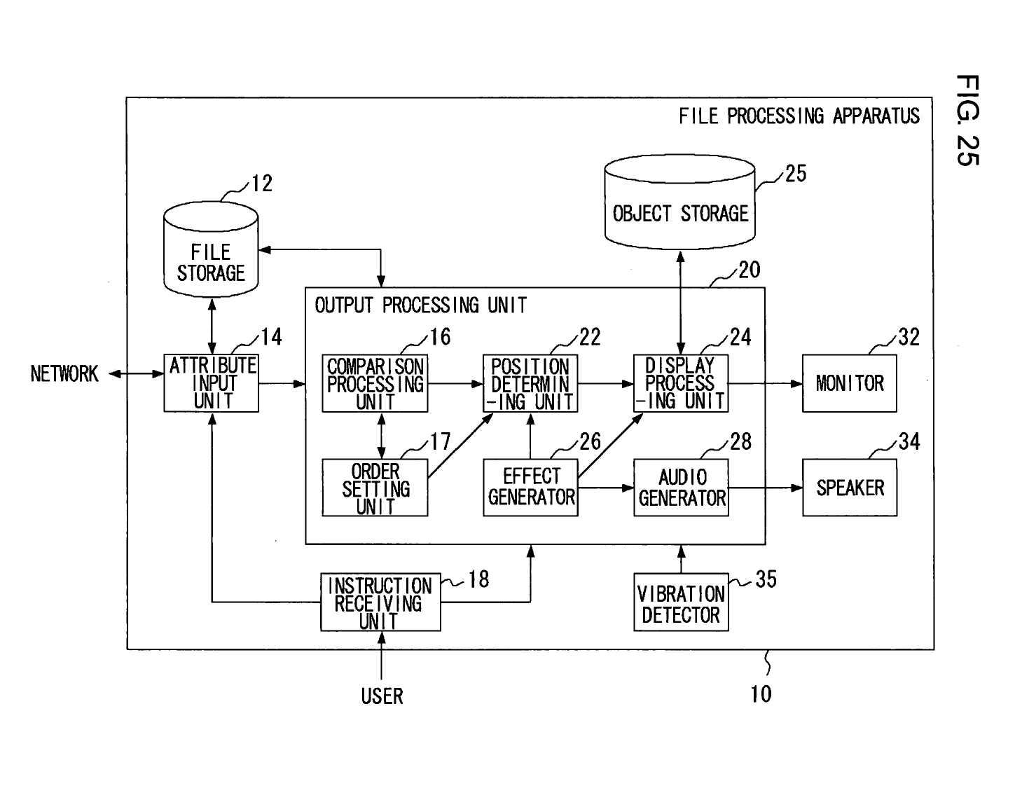

FIG. 25 is a functional block diagram showing a structure of a file processing apparatus 10 according to the eighth embodiment. An output processing unit 20 in this eighth embodiment differs from the one in the seventh embodiment in that it further includes a vibration detector 35.

The vibration detector 35 detects the sway of a predetermined position of a file processing unit 10 which is operated by the user. Although the predetermined position of a file processing unit 10 in this eighth embodiment is the whole body of the PDA 140, it may be a controller if the applicable equipment is a game machine. The vibration detector 35 may employ a piezo-electric element to detect the sways, and the sways to be detected may be any of up and down, right and left, and vertical sways relative to the screen. Whenever the vibration detector detects a sway exceeding a predetermined threshold value, the vibration detector 35 causes the comparison processing unit 16 to perform a comparison processing, the order setting unit 17 to perform a rearrangement processing, the position determining unit 22 to perform an update processing of display positions, and the display processing unit 24 to perform a display processing.

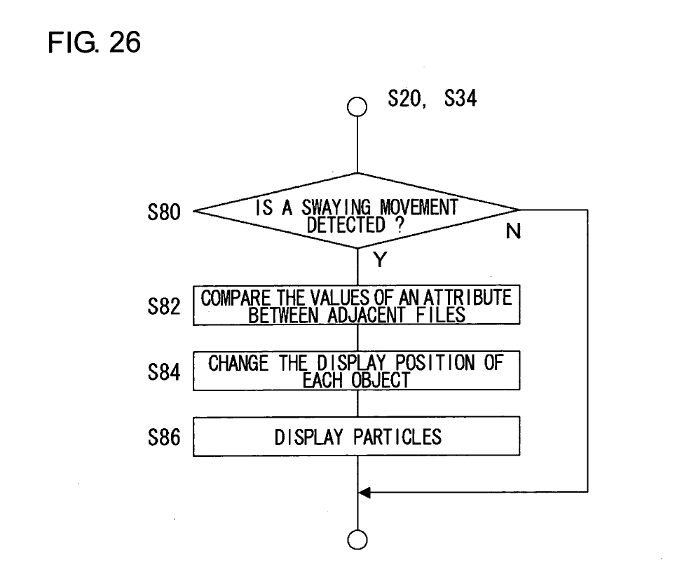

FIG. 26 is a flowchart showing a process of moving objects, which are a plurality of particles placed in a box, by swaying the whole body of a PDA. A basic processing flow in a file processing apparatus 10 according to the eighth embodiment is as shown in FIG. 5. FIG. 26 represents a flow to replace S20 and S34 of FIG. 5. At S14 and S28 in FIG. 5, the order setting unit 17 determines a temporary order and the position determining unit 22 sets temporary display positions in this temporary order. At S18 and S32, the objects are displayed temporarily. Referring to FIG. 26, when the vibration detector 35 detects a sway exceeding a threshold value (S80), the comparison processing unit 16 compares the values of an attribute between adjacent files in a temporary order and the order setting unit 17 updates the order based on the results of comparison (S82). In the updated order, the position determining unit 22 changes the display position of each object (S84) and the display processing unit 24 displays the particles in their respective positions (S86).

Since the processings of S18 to S20 and S32 to S34 in FIG. 5 are repeated, the processings of S80 to S86 in FIG. 26, which belong to those steps, are also repeated, so that the positions of particles are changed whenever a sway of the PDA 140 is detected. It is to be noted that in this eighth embodiment, the rearrangement in an ascending order is accomplished gradually by changing the positions of particles whenever a sway of the PDA 140 is detected, but in other embodiments, the process of rearrangement may be carried out all at once. Namely, when a sway of the PDA 140 is detected for the first time, the processing for rearranging the particles may be carried out until the rearrangement in an ascending order is completed without waiting for the detection of a next sway. In such a case, the rearrangement may be performed by a sort method, such as a simple selection method.

The present invention has been described based on the embodiments which are only exemplary. It is understood by those skilled in the art that there exist other various modifications to the combination of each component and process described above and that such modifications are encompassed by the scope of the present invention. Such modified examples will be described hereinbelow.

In each of the above-described embodiments, the objects to be compared or measured are files or folders stored in a storage in the file processing apparatus 10. As a modified example, the objects may be files or folders stored in a node of a network. In such a case, the file processing apparatus 10 is provided with a communication function for accessing the network. The file processing apparatus 10 may display network files and local files on the same screen without making distinction. As a result, the user can handle files and folders without being conscious of the network.

The third embodiment is structured such that the inclination of a PDA 140 as a whole is detected and the positions of objects are changed according to the inclination. As another modified example, the inclination of a predetermined position of a system, such as the controller of a game machine, may be detected. Such a controller may have a built-in tilt sensor.

In each of the embodiments, the function for changing the positions or forms of objects in response to user instructions has been described. As still another modification, sound effect may be produced along with these changes in the display. For example, such sound effects may include the sound of a sphere bouncing, the sound of water splashing, or the sound of a balloon bursting. Moreover, such other directing and manipulating effects as vibration of the controller or stronger repulsion of the stick of a game machine may be added to the above sound effect.

In the eighth embodiment, the user can instruct a classification of files by swaying the whole PDA 140. A file processing apparatus 10 according to still another modified example may have a function for instructing a classification not via the vibration detector 35 but via a control device, such as a keyboard, a mouse or a controller of a game machine.

In the seventh and eighth embodiments, the rearrangement of files is processed by utilizing the bubble sort method. As still another modified example, another sorting method, such as simple sort, quick sort or shaker sort, may be employed. In the seventh and eighth embodiments, objects are initially displayed in random display positions as the initial display state. As still another modified example, the objects may be displayed in positions corresponding to the values of an attribute from the beginning.

In the sixth embodiment, the arrangement is such that objects are roughly classified into appearances corresponding to their weights, whereas in the seventh and eighth embodiments, the objects are subjected to rearrangements corresponding to their weights. As still another modified example, a structure may be such that the objects are first classified roughly into appearances corresponding to their weights and then further subjected to rearrangements corresponding to their weights.

In the sixth embodiment, a plurality of particles placed in a box 180 are displayed in random positions. As still another modified example, the plurality of particles in the box 180 may, for instance, be divided into three ranges of lower, middle and upper ranges, and the position determining unit 22 as shown in FIG. 2 may set the display position of first particles 182 in the lower range, the display position of second particles 184 in the middle range, and the display position of third particles 186 in the upper range. In a modified example like this, the display positions of particles vary from group to group, so that the user can roughly classify files by the difference in display position.

Although the present invention has been described by way of exemplary embodiments, it should be understood that many changes and substitutions may further be made by those skilled in the art without departing from the scope of the present invention which is defined by the appended claims.

What is claimed is:

1. A file processing apparatus, including:
an attribute input unit which acquires a value of an attribute for at least one file in order to represent a value of a predetermined attribute for an intended file by using a concept of weight;
a comparison processing unit which compares the value of an attribute with a reference value;
a position determining unit which sets, based on a result obtained from said comparison processing unit, a relative display position of a predetermined object that represents symbolically the weight; and
a display processing unit which visually represents the value of the attribute in terms of whether the weight is heavy or light, by displaying the object at the display position on a screen set by said position determining unit.

2. A file processing apparatus according to claim 1, further including an inclination detector which detects inclination of a predetermined region in the file processing apparatus operated by a user, wherein according to the inclination detected by said inclination detector said position determining unit varies the relative display position.

3. A file processing apparatus according to claim 1, wherein said attribute input unit acquires values of the attribute for a plurality of files, said comparison processing unit sets a value of an attribute for at least one of the plurality of files to the reference value, said position determining unit sets relative display positions of a plurality of objects corresponding to the plurality of files, respectively, and wherein said display processing unit displays the plurality of files at the respective display positions and visually represents the comparison of weights of the files via another object representative of the measurement of the weights.

4. A file processing apparatus according to claim 3, wherein said comparison processing unit sets, as the reference value, a size of a storage area that stores at least one file, said position determining unit sets a relative display position of an object indicative of the storage area according to the size of the storage area, and wherein said display processing unit visually expresses the comparison of data size between the at least one file and the storage area via the another object.

5. A file processing apparatus according to claim 1, wherein said attribute input unit acquires values of an attribute for a plurality of files and said comparison processing unit classifies the plurality of files into a plurality of groups according to the respective values of the attribute, and wherein said display processing unit displays the object in an appearance corresponding to the respective groups.

6. A file processing apparatus according to claim 1, wherein said attribute input unit acquires values of an attribute for a plurality of files, said comparison processing unit classifies the plurality of files into a plurality of classes and sequentially compares the values of an attribute for each class, wherein, after relative display positions are temporarily determined respectively as positions that initially display objects for the plurality of files, said position determining unit sequentially updates the relative display positions in a manner such that comparison results for each class are reflected for each class, and wherein said display processing unit varies the display of the objects according to said updating after the plurality of files are displayed at the temporally determined relative display positions.

7. A file processing apparatus according to claim 5, further including a vibration detector which detects a swaying motion at a predetermined region of the file processing apparatus operated by a user, wherein said comparison processing unit performs a comparison processing when the motion is detected, and said position determining unit updates the relative display position according to the result obtained from said comparison processing unit.

8. A file processing apparatus according to claim 6, further including a vibration detector which detects a swaying motion at a predetermined region of the file processing apparatus operated by a user, wherein said comparison processing unit performs a comparison processing when the motion is detected, and said position determining unit updates the relative display position according to the result obtained from said comparison processing unit.

9. A file processing apparatus according to claim 1, further including:
an instruction receiving unit which receive an instruction from a user intending to change the display position of the object; and
an effect generator which causes, based on the instruction, said position determining unit and said display processing unit to process a change in any of position, shape and appearance of the object.

10. A method of processing files, including:
setting a relative display position of a predetermined object that symbolically represents the files in terms of whether the weight thereof is heavy or light, based on a value of a predetermined attribute for an intended file, in order to represent the value of a predetermined attribute therefor by using a concept of weight; and
representing visually the weight by displaying the object at the relative display position on a screen.

11. A method of processing files according to claim 10, further including:
detecting inclination of a predetermined apparatus operated by a user; and
varying the relative display positions according to the inclination.

12. A method of processing files, including:
acquiring values of a predetermined attribute for a plurality of intended files in order to represent the values of a predetermined attribute therefor by using a concept of weight;
setting, for each of the plurality of files, a relative display position of a predetermined object that represents symbolically the files in terms of whether the weight thereof is heavy or light, based on the values of a predetermined attribute; and
displaying the objects of the plurality of files at the respective display positions on a screen, and expressing visually comparison of the weights of the objects via another object that symbolizes weight measurement.

13. A method of processing files according to claim 12, wherein said acquiring further acquires a size of a storage area that stores at least one file, and said setting sets the relative display position of at least one object corresponding to the at least one file, based on a comparison result obtained by comparing a data size between the at least one object and the storage area, and wherein said displaying and expressing represents visually the comparison result via the another object.

14. A method of processing files, including:
acquiring values of a predetermined attribute for a plurality of files, in order to represent the values of a predetermined attribute for intended files by using a concept of weight;
setting a temporary sequence for the plurality of files;
determining, based on the temporary sequence, a temporary display position of a predetermined object that symbolically represents the files in terms of whether the weight thereof is heavy or light;
displaying an object that corresponds to the plurality of files, at the temporary display position on a screen;
comparing the values of a predetermined attribute between adjacent files in the temporary sequence;
updating the display position based on a comparison result obtained from said comparing; and
representing visually the weight thereof by varying display contents according to said updating.

15. A method of processing files according to claim 14, further including:
detecting a swaying motion of a predetermined apparatus operated by a user;
performing said comparing when the swaying motion is detected in said detecting;
updating a relative display position of the object according to the comparison result.

16. A method of processing files according to claim 10, further including:
acquiring an instruction from a user who intends to cause a display position of the object to be changed; and
changing at least one of position, shape and appearance of the object, based on the instruction.

17. A program executable by a computer, the program including the functions of:
setting a relative display position of a predetermined object that symbolically represents the files in terms of whether the weight thereof is heavy or light, based on a value of a predetermined attribute for an intended file, in order to represent the value of a predetermined attribute therefor by using a concept of weight; and
representing visually the weight by displaying the object at the relative display position on a screen.

18. A program executable by a computer, the program including the functions of:
acquiring values of a predetermined attribute for a plurality of intended files in order to represent the values of a predetermined attribute therefor by using a concept of weight;
setting, for each of the plurality of files, a relative display position of a predetermined object representing symbolically the files in terms of whether the weight thereof is heavy or light, based on the values of a predetermined attribute; and
displaying on a screen the objects of the plurality of files at the respective display positions, and expressing visually comparison of the weights of the objects via another object that symbolizes weight measurement.

19. A program executable by a computer, the program including the functions of:
acquiring values of a predetermined attribute for a plurality of files, in order to represent the values of a predetermined attribute for intended files by using a concept of weight;
setting a temporary sequence for the plurality of files;
determining, based on the temporary sequence, a temporary display position of a predetermined object that symbolically represents the files in terms of whether the weight thereof is heavy or light;
displaying an object that corresponds to the plurality of files, at the temporary display position on a screen;
comparing the values of a predetermined attribute between adjacent files in the temporary sequence;
updating the display position based on a comparison result obtained from said comparing; and
representing visually the weight thereof by varying display contents according to said updating.

20. A computer-readable recording medium which stores a program executable by a computer, the program including the functions of:
setting a relative display position of a predetermined object that symbolically represents the files in terms of whether the weight thereof is heavy or light, based on a value of a predetermined attribute for an intended file, in order to represent the value of a predetermined attribute therefor by using a concept of weight; and
representing visually the weight by displaying the object at the relative display position on a screen.

21. A computer-readable recording medium which stores a program executable by a computer, the program including the functions of:
acquiring values of a predetermined attribute for a plurality of intended files in order to represent the values of a predetermined attribute therefor by using a concept of weight;
setting, for each of the plurality of files, a relative display position of a predetermined object representing symbolically the files in terms of whether the weight thereof is heavy or light, based on the values of a predetermined attribute; and
displaying on a screen the objects of the plurality of files at the respective display positions, and expressing visually comparison of the weights of the objects via another object that symbolizes weight measurement.

22. A computer-readable recording medium which stores a program executable by a computer, the program including the functions of:
acquiring values of a predetermined attribute for a plurality of files, in order to represent the values of a predetermined attribute for intended files by using a concept of weight;
setting a temporary sequence for the plurality of files;
determining, based on the temporary sequence, a temporary display position of a predetermined object that symbolically represents the files in terms of whether the weight thereof is heavy or light;
displaying an object that corresponds to the plurality of files, at the temporary display position on a screen;
comparing the values of a predetermined attribute between adjacent files in the temporary sequence;
updating the display position based on a comparison result obtained from said comparing; and
representing visually the weight thereof by varying display contents according to said updating.
